(19) United States
(12) Patent Application Publication
(10) Pub. No.: US 2019/0310063 A1
(43) Pub. Date: Oct. 10, 2019

(54) DESTRUCTION OF AIR BAG INFLATORS BY SHREDDING UNDER WATER

(71) Applicant: BioSafe Engineering, LLC, Indianapolis, IN (US)

(72) Inventor: Brandon Ross, Brownsburg, IN (US)

(73) Assignee: BioSafe Engineering, LLC, Indianapolis, IN (US)

(21) Appl. No.: 16/376,666

(22) Filed: Apr. 5, 2019

Related U.S. Application Data
(60) Provisional application No. 62/653,000, filed on Apr. 5, 2018.

(51) Int. Cl. F42D 5/04; B02C 23/36; B02C 18/22

(52) U.S. Cl. CPC F42D 5/04; B02C 18/2216; B02C 18/2241; B02C 23/36

(57) ABSTRACT

A method for disposing of propellant containers containing a propellant, comprising submerging the propellant containers in a detonation suppressant liquid, shredding the propellant containers while submerged in the detonation suppressant liquid into shredded propellant container material reduced in size to provide release of the propellant from the propellant containers, and removing the shredded propellant container material from the detonation suppressant liquid. A system for disposing of propellant containers is also disclosed.

### CROSS-REFERENCE TO RELATED APPLICATION

This application claims the benefit of U.S. Provisional Application No. 62/653,000 filed Apr. 5, 2019, which is hereby incorporated by reference.

### BACKGROUND

Air bags are commonly used as a safety device in automobiles and other vehicles. An air bag system includes three parts. The bag itself is a flexible fabric bag, such as made from a thin, nylon fabric, folded into the steering wheel, dashboard, side doors and other portions of a vehicle. A sensor tells the bag when to inflate, for example by detecting a collision force equivalent to running into a brick wall at 10 or 15 miles per hour (16 to 24 kph).

The air bag system also includes an inflation component which uses a chemical reaction to create a sudden and rapid expansion of a gas. In one embodiment, for example, sodium azide (NaN₃) is very quickly reacted with potassium nitrate (KNO₃) to produce a large pulse of hot nitrogen gas. This gas inflates the bag, which literally bursts out of the steering wheel or other storage location as it expands. About a second later, the air bag is already deflating (it has holes in it) in order to get out of the way of the occupants of the vehicle. It will be appreciated that other propellant systems, i.e., gas generators, are also known, and continue to be developed.

Signals from various sensors are used to inform the airbag control unit as to the angle of impact and severity of a crash, as well as other variables. An electric match, which consists of an electrical conductor wrapped in a combustible material, activates with a current pulse between 1 and 3 amperes in less than 2 milliseconds. When the conductor becomes hot enough, it ignites the combustible material, which initiates the gas generator.

The current technologies and techniques for disposal of airbag inflators and the associated explosives or propellants are limited by the nature of the disposal techniques and the use of incineration technology. This prior art method introduces numerous operational and environmental issues including: ignition of the propellant, the need to scrub gasses produced during the incineration of the inflator and airbag casing, and noise pollution/hazard to the surrounding environment and operator because of the propellant detonation. Additionally, the throughput capacity of the incineration design is limited and does not provide for the required capacity to keep up with industry demand. Thus, there is a need for improvement in this field.

### SUMMARY

A method is disclosed for disposing of propellant containers containing a propellant, the method including submerging the propellant container in a detonation suppressant liquid, shredding the propellant containers while submerged in the detonation suppressant liquid into shredded propellant container material reduced in size to provide release of the propellant from the propellant containers, and removing the shredded propellant container material from the detonation suppressant liquid. The method is particularly suited for disposing of propellant containers from inflation components of airbag systems. In another aspect, there is provided a system for disposing of propellant containers containing a propellant, comprising a chamber containing a detonation suppressant liquid, the chamber including an inlet for receiving propellant containers and an opening for discharging shredded propellant container material, a shredder including shredder components received within the chamber and submerged in the detonation suppressant liquid, an inlet conveyor configured to deliver propellant containers into the inlet of the chamber, and a discharge conveyor configured to deliver shredded propellant container material away from the chamber, the shredded propellant container material being of a size to provide release of the propellant from the propellant containers.

It is an object of the present invention to provide an efficient method and system for disposing of propellant containers, while also reducing the risk related to potential detonation of the propellant containers.

Further objects and advantages of the present invention will become apparent from a detailed description provided herewith.

### BRIEF DESCRIPTION OF THE DRAWINGS

FIG. 1 is a side, diagrammatic view of a system for disposal of propellant containers in accordance with the present invention.

FIG. 2 is a top, diagrammatic view of the system of FIG. 1.

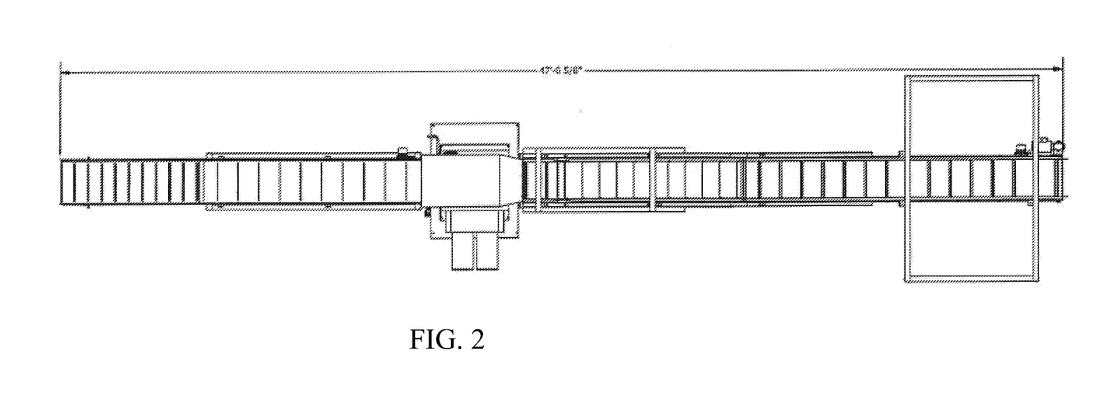

### DESCRIPTION OF THE SELECTED EMBODIMENTS

For the purpose of promoting an understanding of the principles of the invention, reference will now be made to the embodiment illustrated herein and specific language will be used to describe the same. It will nevertheless be understood that no limitation of the scope of the invention is thereby intended. Any alterations and further modifications of the invention, and any further applications of the principles of the invention as described herein, are contemplated as would normally occur to one skilled in the art to which the invention relates. One embodiment of the invention is shown in great detail, but it will be apparent to those skilled in the relevant art that some features that are not relevant to the present invention may not be shown for the sake of clarity.

The present invention is useful in the disposal of a variety of materials containing propellants. As used herein, the term “propellant” applies to any material or combination of materials operable to create by a chemical reaction a sudden and rapid expansion of a gas that functions to propel the movement of something. A propellant may comprise, for example, a combination of a fuel and an oxidizer. The propellant may be contained in a variety of propellant containers. In one embodiment, for example, the present invention has particular application in the disposal of the propellant containers consisting of inflation components of air bag systems.

There may also be a secondary charges associated with the propellant. The secondary charge functions to ignite. As noted previously, there typically is an electric match or other triggering device which ignites the combustible material, which initiates the gas generation. There also are “dual-stage” airbags in which separate charges are available in succession, depending on the severity of the crash.

The propellant containers are processed by first submerging them into a chamber containing a detonation suppressing liquid. As used herein, the term “detonation suppressing liquid” refers to a liquid which diminishes or eliminates the effect of the chemical reaction used by a propellant. In one embodiment, the detonation suppressing liquid is one which diminishes or eliminates the gas expansion of a propellant when the propellant is contained within the liquid. The detonation suppressing liquid may, for example, diminish or eliminate the chemical reaction used by inflation components of air bag systems. The detonation suppressing liquid may also have a function to minimize the effect of any expansion of gas that does take place, such as by absorbing some of the impact of the gas expansion. In a particular aspect, the detonation suppressing liquid is water. Other liquids of varying compositions and characteristics, such as viscosity, may be used depending on the propellant.

The system also includes a shredder for receiving the propellant containers and shredding them into propellant container material having a size ensuring release of the propellant. The term “shredding” is used in a sense to encompass any device and method which is capable of mechanically reducing the size of the propellant containers to the indicated sizes. The shredder includes shredder components received with the chamber and positioned to act upon the propellant containers while they remain submerged in the detonation suppressant liquid. The propellant containers are thereby shredded to produce a resulting material having sizes sufficiently small to provide release of the propellant from the propellant containers, while providing protection against detonation of the propellant in the process. The resulting shredded material may then be removed from the liquid and disposed of in a conventional manner.

In a particular aspect of the invention, the method is used to dispose of the inflation components of airbag systems. In another aspect, the detonation suppressant liquid is water.

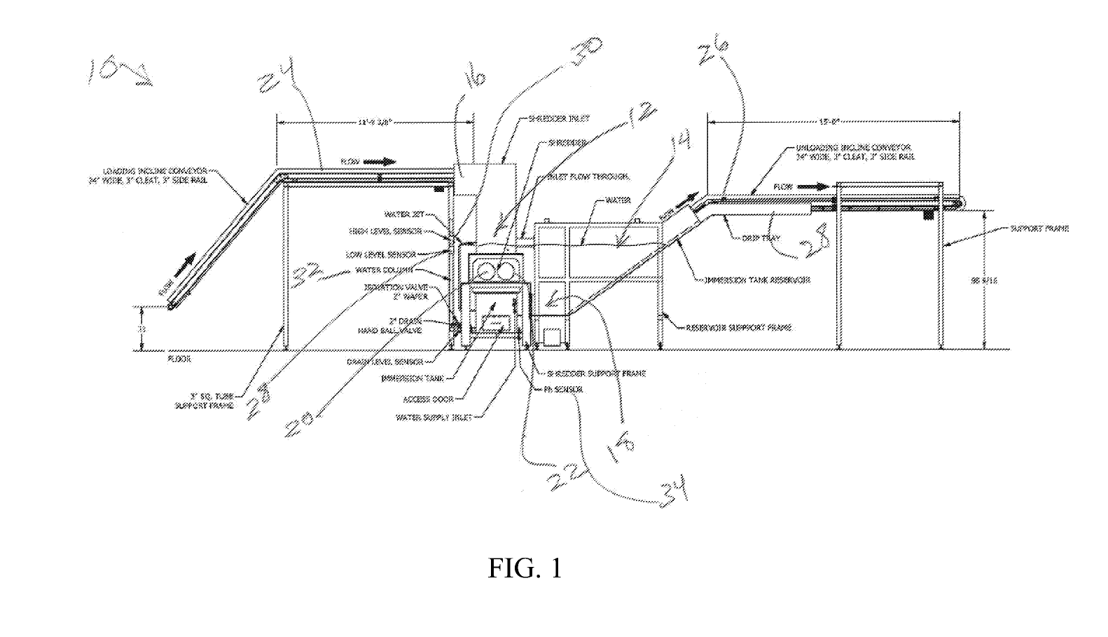

Referring to FIG. 1, there is shown in diagrammatic form a system operable in accordance with the present invention. In general, the system is for disposing of detonation containers containing a propellant. The system comprises a chamber containing a detonation suppressant liquid. The chamber also includes an inlet for receiving propellant containers and an opening for discharging shredded propellant container material. A shredder has shredder components received within the chamber and submerged in the detonation suppressant liquid. An inlet conveyor is configured to deliver propellant containers into the inlet of the chamber. A discharge conveyor is configured to deliver shredded propellant container material away from the chamber, the shredded propellant container material being of a size to provide release of the propellant from the propellant containers.

Disposal system 10 includes a chamber 12 containing a detonation suppressant liquid 14, e.g., water. Chamber 12 includes an inlet 16 for receiving propellant containers, and an outlet 18 for discharging shredded propellant containers. A shredder 20 is operably connected with chamber 12 to receive the propellant containers. Shredder 20 includes shredder components 22 that are received within the chamber and are submerged in the detonation suppressant liquid 14.

As shown in FIG. 1, in one embodiment there is provided an inlet conveyor 24 configured to deliver propellant containers into the inlet 16 of chamber 12. In the embodiment of FIG. 1, the propellant containers are provided as a gravity feed from the inlet of chamber 12 to the shredder components 22 of shredder 20. Other components of shredder 20, such as a motor and electronics (not shown) are positioned outside of, but adjacent to, chamber 12.

A discharge conveyor 26 is configured to deliver shredded propellant container material away from chamber 12. As shown in FIG. 1, discharge conveyor 26 may include a portion at the outlet of chamber 12 to receive the shredded propellant container material thereon. Discharge conveyor 26 continues upward at an angle away from chamber 12 to allow for a gravity feed of the material to a removal system. A drip tray 28 is provided to further catch liquid being drained from the shredded propellant container material as it travels along discharge conveyor 26.

Provisions are made to ensure a proper level of detonation suppressant liquid within chamber 12 in order keep the shredder components 22 submerged during the shredding process. Accordingly, the system includes a low level sensor 28 provides for detection of a minimum predetermined level of the detonation suppressant liquid for chamber 12. High level sensor 30 provides for detection of a maximum predetermined level of the detonation suppressant liquid for chamber 12. The system further includes a controller (not shown) for maintaining the level of detonation suppressant liquid in chamber 12 between the minimum level and the maximum level. Exterior water column 32 allows for visual confirmation of the water level in chamber 12. A pH sensor 34 is provided to monitor the conditions of the water solution to determine when the water needs to be neutralized and changed for safety.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A method for disposing of propellant containers containing a propellant, comprising:
submerging the propellant containers in a detonation suppressant liquid;
shredding the propellant containers while submerged in the detonation suppressant liquid into shredded propellant container material reduced in size to provide release of the propellant from the propellant containers; and
removing the shredded propellant container material from the detonation suppressant liquid.

2. The method of claim 1 in which the propellant containers are inflation components of airbag systems.

3. The method of claim 2 in which the detonation suppressant liquid is water.

4. A system for disposing of propellant containers containing a propellant, comprising:
a chamber containing a detonation suppressant liquid, said chamber including an inlet for receiving propellant containers and an opening for discharging shredded propellant containers;
a shredder including shredder components received within said chamber and submerged in the detonation suppressant liquid;
an inlet conveyor configured to deliver propellant containers into the inlet of said chamber; and
a discharge conveyor configured to deliver shredded propellant container material away from said chamber, the shredded propellant container material being of a size to provide release of the propellant from the propellant container material.

5. The system of claim 4 and further including a low level sensor for detecting a minimum predetermined level of the detonation suppressant liquid in said chamber, and a high level sensor detecting a maximum predetermined level of the detonation suppressant liquid in said chamber.

6. The system of claim 5 and further including a controller for maintaining the level of detonation suppressant liquid in said chamber between the minimum level and the maximum level.
